(19) United States
(12) Patent Application Publication
(10) Pub. No.: US 2015/0124445 A1
(43) Pub. Date: May 7, 2015

(54) LIGHT EMITTING DIODE LIGHT BOX

(71) Applicant: Research Cooperation Foundation of Yeungnam University, Gyeongsan-si (KR)

(72) Inventors: Si Hyun PARK, Daegu (KR); Hao CUI, Gyeongsan-si (KR); Won Sik CHOI, Gwangju (KR)

(21) Appl. No.: 14/527,771

(22) Filed: Oct. 30, 2014

(30) Foreign Application Priority Data
Nov. 5, 2013 (KR) 10-2013-0133692

(51) Int. Cl. G02B 5/02; F21V 7/05

(52) U.S. Cl. CPC G02B 5/021; F21V 7/05; F21Y 2101/02
USPC 362/235

(57) ABSTRACT

There is provided a light emitting box, comprising a main body having an open region in upper part, closed sides and a space in the main body; a light emitting module placed on the bottom of the space of the main body, having a plurality of light emitting units for emitting the light through the open region; a diffusion sheet placed in the upper part, diffusing the light directly or indirectly from the light emitting module; and reflecting plate placed in at least one side of sides, reflecting the light from the light emitting module to the diffusion sheet.

### CROSS REFERENCE TO RELATED APPLICATIONS

This application claims the benefit of Korean Patent Application No. 10-2013-0133692, filed on Nov. 5, 2013, which is hereby incorporated by reference as if fully set forth herein.

### FIELD OF THE INVENTION

The invention related to a light emitting diode, more specifically, a LED light box having a uniform luminescence over the whole illumination area even with strong directness of LED light.

### BACKGROUND OF THE INVENTION

Generally, a light box is an advertising tool placed in outdoor which contains an advertising sheet such as letters, drawings, and a photo in a main frame. The structure of the light box, for example, has a light source in the main frame and a transparent advertising sheet is placed in front of the light source in the main frame. The light from the light source penetrates through the transparent advertising sheet. The transparent advertising sheet is attached to the main frame.

It is normal that the light box uses fluorescence lighting. However, the life time of the fluorescence light is not long. For example, commercial 40 W fluorescence light has a life time of about 1200 hours. The short lifetime of the fluorescence light sometimes causes a big problem. If the commercial light box stands in high position of building for advertisement, it is hard and expensive to change the fluorescence light of the commercial light box.

To solve the problem, LED light boxes have been suggested. For example, there is a Japanese Publication No. 10-83148. The invention discloses that LED light modules are placed on reflection plate and the transparent plastic plate is provided in front of the LED modules. Using the LED modules, the life time of the light boxes can be dramatically increased. But, the invention still has a problem. When LED modules are provided on the reflection plate, non-uniformity issues happen in the luminescence over the area through which the light transmits. It is because of the light of LED has a naturally strong directness.

### PRIOR ARTS

### PATENT DOCUMENT

(Patent Document 1) Japanese Publication No. 10-83148

(Patent Document 2) Korean Publication No. 2010-0010524

### SUMMARY OF THE INVENTION

To solve the problem, the object of the invention is to provide a LED light box having a uniform luminescence over the whole illumination area even with strong directness of LED light.

The another object of the invention is to provide a LED light box efficiently applicable to advertisement screen, medical device such as X-ray reader screen, LED area lighting, liquid crystal display, because human can feel comfortable even if human sees the LED light box directly, as well as uniformity.

In accordance with an aspect of the invention, there is provided a light emitting box, comprising: a main body having an open region in upper part, closed sides and a space in the main body; a light emitting module placed on the bottom of the space of the main body, having a plurality of light emitting units for emitting the light through the open region; a diffusion sheet placed in the upper part, diffusing the light directly or indirectly from the light emitting module; and a reflecting plate placed in at least one side of sides, reflecting the light from the light emitting module to the diffusion sheet.

Preferably, the light box further includes diffusion patterns having protrusions inside surface of the diffusion sheet, for diffracting or scattering the lights.

Preferably, the diffusion patterns have con shape and the cross section of the con shape may be circle, ellipse, triangle, square, or polygon. More preferable, the cross section is the triangle.

Preferably, the reflecting plate may be provided in all sides, for transmitting the light from the light emitting module to the diffusion sheet.

Preferably, the bottom of the main body further includes a reflecting plate thereon.

According to the invention, the LED light box can have a uniform luminescence over the whole illumination area even with strong directness of LED light. The LED light box is efficiently applicable to advertisement screen, medical device such as X-ray reader screen, LED area lighting, a liquid crystal display.

### BRIEF DESCRIPTION OF THE DRAWINGS

The above and other objects and features of the present invention will become apparent from the following description of the embodiments given in conjunction with the accompanying drawings, in which:

FIG. 1 shows a perspective of LED light box according to an embodiment of the invention;

FIG. 2 shows a cross section view of LED light box according to an embodiment of the invention; and

FIG. 3 is a graph showing illuminations of the light box according to the embodiment of the invention and conventional light box.

### DETAILED DESCRIPTION OF THE EMBODIMENTS

Hereafter, the embodiments of the present invention will be described in detail with reference to the accompanying drawings. However, the embodiments of the present invention as illustrated below may be modified in various different forms, and the scope of the present invention is not intended to limit the embodiments as set forth above. It should be noted that the embodiments are provided to make a full disclosure and also to allow those skilled in the art to know the full scope of the present invention.

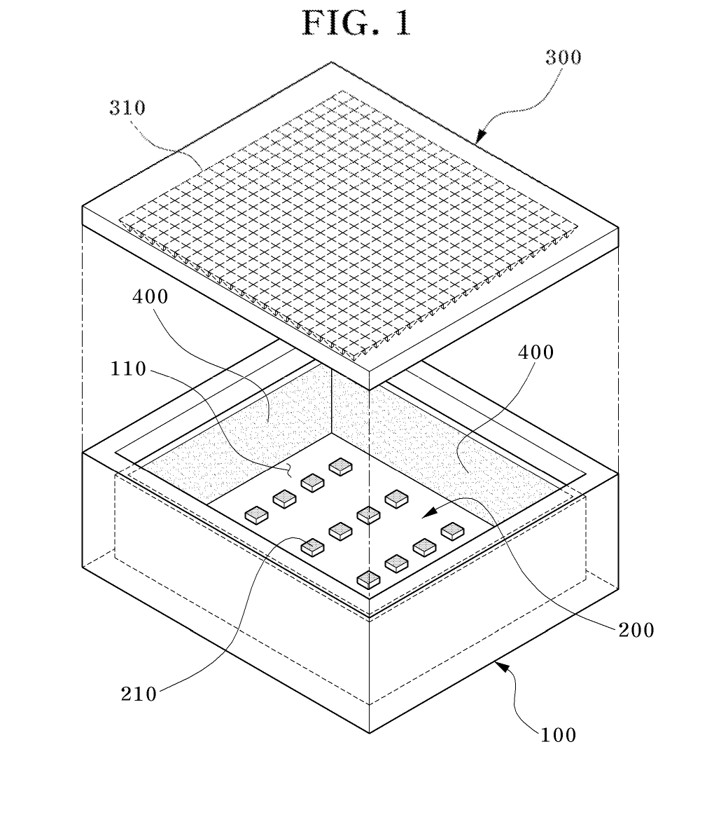

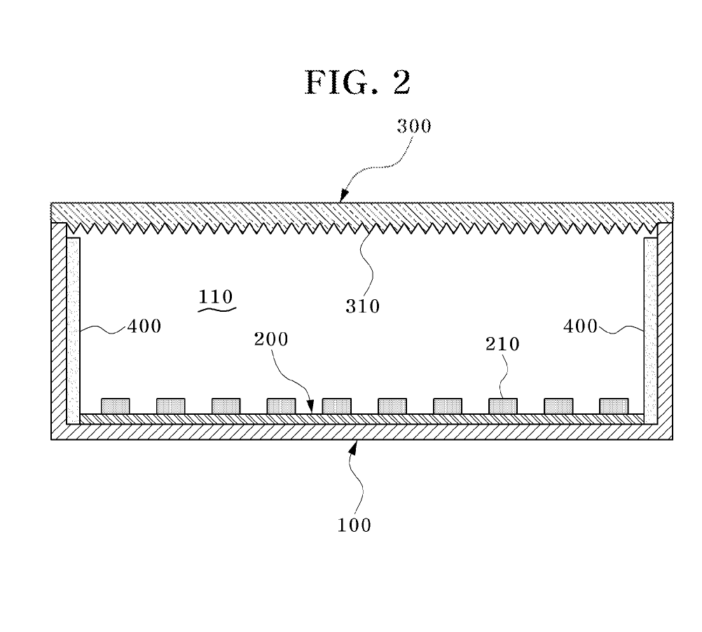

FIG. 1 shows a perspective of LED light box according to an embodiment of the invention. FIG. 2 shows a cross section view of LED light box according to an embodiment of the invention.

Referring to FIGS. 1 and 2, the LED light box according to an embodiment of the invention includes a main body 100, a light emitting module 200, a diffusion sheet 300, and reflecting plate 400, and so on.

The main body 100 has an open region in upper part, closed sides and a space 110 in the main body. Preferably, the main body 100 has a cubic shape. The cross section of the main body 100 is a rectangle. But, the shape of the main body 10 is not limited to the cubic shape and any kinds of shapes. For example, the cross section of the main body 100 may be circle, ellipse, triangle, multi square, or polygon. The reflection means (not shown) is placed on or is the bottom of the space of the main body.

The main body 100 may be a cubic shape with the space 110 therein. The upper part of the main body 100 is open. The light emitting module 200 is placed on the bottom of the space of the main body 100. The reflecting plate 400 is placed on at least one side of sides.

The light emitting module 200 has a plurality of light emitting units 210 for emitting the light through the open region.

The light emitting module 200 has the structure that a plurality of light emitting units 210 is formed on the general Printed Circuit Board (PCB). The operation of the light emitting module 200 may be controlled by LED control unit (not shown). A number of the light emitting units are adjusted according to the size of the space 210 of the main body 100.

In case the plurality of light emitting units 210 are attached on the Printed Circuit Board (PCB), if the area size of Printed Circuit Board (PCB) is larger than that of the main body 100, it is preferable that the reflection plate is placed on the Printed Circuit Board (PCB).

The diffusion sheet 300 is placed in the upper part of the main body 100 in order to close the main body 100. The diffusing sheet 300 diffuses the light directly or indirectly from the light emitting module 200. “Directly” means that the light comes from the light emitting module 200 without reflection. “Indirectly” means that the light comes from the light emitting module 200 with reflection on sides or bottoms.

The light emitting module 200 is provided on the bottom area of the main body 100. The diffusion sheet 300 is placed in the upper part of the main body 100. The diffusion sheet 300 functions as diffusing the light from the light emitting units 210. Preferably, the diffusion sheet 300 has an area size to cover the upper part of the main body 100

The material of the diffusion sheet 300 is glass, acrylic resin, Polymethylmethacrylate, polycarbobate, Arton, polystyrene, methacrylate styrene, PET, and so on. The material of the diffusion sheet 300 is transparent or semi-transparent.

The light box further includes diffusion patterns 310 having protrusions inside surface of the diffusion sheet 300, for diffracting or scattering the light to forward (front) direction. The diffusion patterns 310 can increase the diffusion of the light. The diffusion patterns 310 may be periodic or non-periodic structure.

The diffusion patterns 310 may be con shape (projection type) with various kinds of cross section. The cross section of the con shape may be cross, circle, ellipse, triangle, square, or polygon. For example, the cross pattern is shown in FIG. 1. The unit of cross pattern has a con shape. It means that the part of the cross pattern which is apart farer from the diffusion sheet 300 has thinner cross pattern. The top of the cross pattern is tip shape. According to other alternative, the diffusion patterns 310 may be different material from that of diffusion sheet 300. Other types of the diffusion patterns 300 may have a Fresnel lenses structure, a lenticular lenses structure, a plurality of micro-lenses, or a pyramid lenses structure.

The amount of diffusion (diffusivity) of the diffusion sheet 300 can be controlled by controlling Fill factor of the diffusion patterns 310. Preferable, the Fill Factor is 80% to 100%. If the Fill Factor is lower than 80%, The increase of the diffusivity is not satisfactory. More preferable, the Fill Factor is 80% to 95%. The Higher Fill Factor can cause the diffusion sheet 300 to have less transparent. Therefore, the higher Fill Factor than 95% has a weak point in luminescence.

The diffusion sheet 300 is the plate that helps transmitting the light uniformly through all area by scattering the direction of the light from the light emitting module 200. The diffusion sheet 300 has an incident-light area in one side and transmitted light area in the other side. The directness of the light from the light emitting module 200 can be dramatically decreased by scattering of the diffusion sheet 300.

The reflecting plate 400 is placed in at least one side of sides of the main body 100 and the reflecting plate 400 reflects the light from the light emitting module 200 to the diffusion sheet 300. Preferably, the reflecting plate 400 is placed on all sides of the main body 100. Additionally, the bottom of the main body further includes a reflecting plate thereon or the bottom of the main body itself is made of reflecting plate. With the reflecting plate in all sides and bottom of the main body, the efficiency of the LED light can be improved.

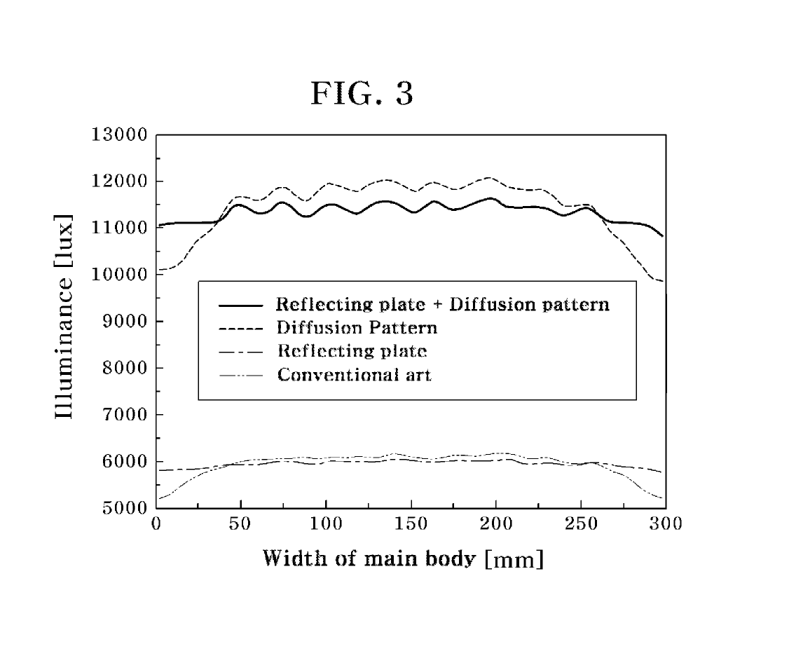

FIG. 3 is a graph showing illuminations of the light box according to the embodiment of the invention and conventional light box.

Referring to FIG. 3, a two dotted chain line represents the conventional LED light box and a dashed dotted line depicts the LED light box with reflection plate. The LED light box with reflection plate shows the improvement of luminescence at edge sides of transmitting area from LED light box. The improvement causes the increase of uniformity in the LED light box.

A dotted line shows the LED light box with diffusion sheet placed in transmitting area. The LED light box with diffusion sheet shows a dramatic increase of luminescence at all areas.

A solid line shows the LED light box with reflection plate and diffusion sheet placed in transmitting area. The LED light box with reflection plate and diffusion sheet shows a dramatic increase of luminescence at all areas and the increase of uniformity in the LED light box.

In FIG. 3, the Fill Factor is 90% and the diffusion patterns have con shape and the cross section of the con shape is cross (trigonal pyramid) and the reflecting plates are provided in all sides.

While the embodiments of the present invention has been described and shown as set forth above, it will be understood by those skilled in the art that various changes and modifications may be made through addition, changes, deletion, or supplement without departing from the scope of the invention as defined in the following claims, and these are intended to be embraced by the scope of the claims of the present invention.

What is claimed is:

1. A light emitting box, comprising:
a main body having an open region in upper part, closed sides and a space in the main body;
a light emitting module placed on the bottom of the space of the main body, having a plurality of light emitting units for emitting the light through the open region;
a diffusion sheet placed in the upper part, diffusing the light directly or indirectly from the light emitting module; and
a reflecting plate placed in at least one side of sides, reflecting the light from the light emitting module to the diffusion sheet.

2. The light emitting box according to claim 1, wherein the light box further includes diffusion patterns having protrusions inside surface of the diffusion sheet, for diffracting or scattering from the light from the light emitting module.

3. The light emitting box according to claim 1, wherein the diffusion patterns have con shape and the cross section of the con shape may be circle, ellipse, triangle, rectangle, or multi-angle.

4. The light emitting box according to claim 1, wherein the reflecting plate is placed in all sides, for reflecting the light from the light emitting module to the diffusion sheet.

5. The light emitting box according to claim 1, wherein the bottom of the main body further includes a reflecting plate thereon.
